(19) United States
(12) Patent Application Publication
(10) Pub. No.: US 2014/0349137 A1
(43) Pub. Date: Nov. 27, 2014

(54) Method for Structuring and Chemically Modifying a Surface of a Workpiece

(71) Applicant: EADS Deutschland GmbH, Ottobrunn (DE)

(72) Inventors: Erhard Brandl, Eitensheim (DE); Ante Kurtovic, Paderborn (DE); Tobias Mertens, Putzbrunn (DE); Dominik Raps, Muenchen (DE)

(21) Appl. No.: 14/366,612

(22) PCT Filed: Dec. 20, 2012
(86) PCT No.: PCT/DE2012/001214

§ 371 Date: Jun. 18, 2014

(30) Foreign Application Priority Data
Dec. 20, 2011 (DE) 10 2011 121 545.3

(51) Int. Cl. B23K 26/00; C22F 3/00; C22F 1/06; B01L 3/00; C22F 1/18; C22F 1/057; C22F 1/04; C21D 10/00; C22F 1/10

(52) U.S. Cl. CPC B23K 26/0078; C21D 10/00; C22F 3/00; C22F 1/06; C22F 1/10; C22F 1/183; C22F 1/18; C22F 1/057; C22F 1/04; B01L 3/5088
USPC 428/687; 219/121.85; 219/74; 428/141; 156/272.8; 427/554

(57) ABSTRACT

A method for producing a chemically modified metal surface or metal alloy surface or metal oxide layer or metal alloy oxide layer on the surface of a workpiece, which surface or layer includes surface structures having dimensions in the sub-micrometer range. The method involves scanning, one or several times using a pulsed laser beam, the entire surface of the metal or metal alloy, or the metal oxide layer or metal alloy oxide layer on the metal or metal alloy, on which surface or layer the structures are to be produced and which is accessible to laser radiation. The scanning is performed in an atmosphere containing a gas or gas mixture that reacts with the surface, such that adjacent flecks of light of the laser beam adjoin each other without an interspace in between or overlap and a predetermined range of a defined relation between process parameters is satisfied.

### CROSS-REFERENCE TO RELATED APPLICATIONS

This application related to PCT International Application PCT/DE2012/001215, filed, Dec. 20, 2012, a national stage of which is U.S. application Ser. No. ______ (Attorney Docket No. 110073.66620US).

### FIELD OF THE INVENTION

Exemplary embodiments of the invention relate to a method for structuring a surface of a workpiece, in which surface structures having dimensions in the sub-micrometer range are produced, wherein the surface is simultaneously chemically modified, and workpieces having surfaces that can be produced therewith.

### BACKGROUND OF THE INVENTION

The wettability with and adhesion of liquid, semi-solid and solid substances on metals and metal oxides depends greatly on the surface condition. This is of great significance in the treatment with or application and adhesion of materials such as, e.g., adhesive, paint, solder, sealants or even biological tissue. Degreasing and other additional cleaning as well as acid-cleaning increase the wettability and adhesion up to a certain degree. These properties still substantially improve with increasing roughness of the surface, i.e., with a larger and more structured surface and therefore increased chemical/mechanical anchoring of the materials to be applied. It is also possible to achieve, e.g., a satisfactory roughness of the surface with anodizing processes; however, the method is relatively complex technically and in some cases involves chemicals that are health hazards. A further disadvantage is that the anodizing processes must be coordinated with a specific metal. Furthermore, anodizing processes consist of multiple individual process steps such as previous cleaning and acid-cleaning prior to the actual anodizing process.

European patent document EP 0 914 395 B1 describes a method for treating an uncleaned metal surface, which comprises the treatment of the surface with an organosilane and the exposure of the surface with a laser.

The chemical modification of metal surfaces or metal oxide surfaces by incorporating atoms or molecules that were not present in the original surface or by removing atoms or molecules that were present in the original surface is known: this includes anodizing methods, e.g. sulfuric acid anodizing, chromic sulfuric acid anodizing (U.S. Pat. No. 4,473,446), sodium hydroxide anodizing (U.S. Pat. No. 4,394,224), NaTESi anodizing (DE 3427543), or plasma pretreatment (Leahy, W., Young, T., Buggy, M. and Barron, V. (2003), A Study of Environmentally Friendly Titanium Pretreatments for Adhesive Bonding to a Thermoplastic Composite, Materialwissenschaft and Werkstofftechnik [Materials Science and Materials Engineering], 34: 415-420. doi: 10.1002/mawe.200390086) and can be used for multifaceted purposes, e.g. activation or passivation, reducing friction or the hydrophobic treatment of the surface, whereby, e.g., an increased corrosive protection and wear protection, an increased wettability during adhesion or a prevention of icing can be achieved.

Exemplary embodiments of the invention are directed to a simple method for producing a good roughness on a metal (alloy) surface, in which the surface is simultaneously chemically modified in a targeted manner.

### SUMMARY OF THE INVENTION

The invention relates to a method for structuring a surface of a workpiece, which surface comprises a metal or a metal alloy or a metal oxide layer or a metal alloy oxide layer present on a metal or metal alloy surface, in which surface structures having dimensions in the sub-micrometer range are produced, in that the entire surface of the metal or the metal alloy or the metal oxide layer or the metal alloy oxide layer on the metal or the metal alloy, which surface or layer is accessible to laser radiation and on which the structures are to be produced, is scanned once or several times by means of a pulsed laser beam such that adjacent flecks of light of the laser beam adjoin each other without an interspace in between or overlap, wherein the following conditions are satisfied:

approx. 0.07≦ε≦approx. 2300

with

$$ɛ = \frac{{P}_{P}^{2} \cdot \sqrt{{P}_{m}} \cdot f \cdot α \cdot \sqrt{t} \cdot \sqrt{κ}}{{d}^{2} \cdot \sqrt{v} \cdot \sqrt{{T}_{V}} \cdot \sqrt{{c}_{P}} \cdot \sqrt{λ}} \cdot {10}^{3}$$

wherein:
Pₚ: Pulse peak power of the exiting laser radiation [kW]
Pₘ: Average power of the exiting laser radiation [W]
t: Pulse length of the laser pulses [ns], wherein t is approx. 0.1 ns to approx. 2000 ns,
f: Repetition rate of the laser pulses [kHz]
v: Scanning speed on the workpiece surface [mm/s]
d: Diameter of the laser beam on the workpiece [μm]
α: Absorption of the laser radiation of the irradiated material [%] under normal conditions
λ: Wavelength of the laser radiation [nm], wherein λ=approx. 100 nm to approx. 11000 nm
Tᵥ: Boiling point of the material [K] under standard pressure
cₚ: Specific heat capacity [J/kgK] under normal conditions
κ: Specific thermal conductivity [W/mK] under normal conditions
wherein the atmosphere, in which the method is carried out, is a gas or gas mixture which reacts with the surface of the metal or the metal alloy or the metal oxide layer or the metal alloy oxide layer on the metal or the metal alloy.

Furthermore, the invention relates to a workpiece, which comprises a surface of a metal or a metal alloy or a metal oxide layer or metal alloy oxide layer on the surface of the metal or the metal alloy, wherein the surface has a chemically modified structure that can be produced by the foregoing method.

### BRIEF DESCRIPTION OF THE FIGURES

FIG. 1 shows a scanning electron microscope (SEM) image of the surface structure of a Ti-6Al-4V sample that was nanostructured in an argon atmosphere.

FIG. 2 shows a SEM image of the surface structure of a Ti-6Al-4V sample that was nanostructured in a nitrogen atmosphere.

FIG. 3 shows a SEM image of the surface structure of an Al 2024 sample that was nanostructured in an oxygen atmosphere.

FIG. 4 shows a SEM image of the surface of an untreated Al 2024 sample.

FIG. 5 shows the comparison between the abrasive wear of a Ti-6Al-4V surface, which has been nanostructured in an argon atmosphere, and the abrasive wear of a Ti-6Al-4V surface, which has been nanostructured in a nitrogen atmosphere.

### DETAILED DESCRIPTION

As mentioned at the outset, the roughening or structuring in the sub-micrometer range of metal surfaces, metal alloy surfaces, metal oxide surfaces and metal alloy oxide surfaces is essential for a good adhesion of adhesives, paints and other coatings. An additional chemical modification of the surface opens up the possibility of conferring the surface with additional properties such as, e.g., a more extensive activation, a passivation, reducing friction or hydrophobic treatment, whereby, e.g., an increased corrosion protection and wear protection, a greater hardness, a high resistance to crack initiation, an increased wettability during adhesion or a prevention of icing can be achieved.

It was now surprisingly found that merely by irradiation with a pulsed laser once or several times under the conditions disclosed herein, chemically modified sub-microstructured (or nanostructured) metal surfaces and metal alloy surfaces can be produced as well as sub-microstructured (or nanostructured) metal (alloy) oxide surfaces if the surfaces have been passivated by an oxide layer; and the surfaces can ensure an excellent adhesion of adhesives, paints, solder, sealants and/or the like and of biological tissue or other coatings, but also an increased corrosion protection and wear protection, a greater hardness or a prevention of icing can be made available. If two metals or one metal are connected together with another material by means of a rolling process at room temperature (e.g., cold rolling of gold) or at increased temperatures (e.g., accumulative roll bonding, laser roll bonding) or by a micro-forging process (e.g., cold gas spraying), the adhesion of said joined materials can be increased, if nanostructures have been produced according to the invention on at least one side.

Depending on the embodiment, generally the surfaces produced can comprise open-pored, ragged and/or fractal-like nanostructures, such as open-pored hill and valley structures, open-pored undercut structures and cauliflower-like or nodule-like structures. At least approx. 80%, preferably at least approx. 90%, even more preferably at least approx. 95% of elevations have a size of <1 μm, which range for example between approx. 10 nm to approx. 200 nm. At least approx. 80%, preferably at least approx. 90%, even more preferably at least approx. 95% of the spaces between likewise have widths <approx. 1 μm, e.g. approx. 10 nm to approx. 50 nm. The length of the “valleys” in the case of hill and valley structures, however, is frequently greater than approx. 1 μm.

As a rule, these types of nanostructures cover at least approx. 90% of the surface calculated as a plane, preferably at least approx. 95%. In the case of optimally coordinated process parameters (in particular repetition rate, scanning speed and focal diameter), the nanostructure can even cover approx. 100% of the surface calculated as a plane.

Scanning the surface with the laser beam can be carried out once or several times in succession. Under some circumstances, an even finer structure can be produced by scanning several times.

The metal surface or metal oxide surface is not normally pretreated or cleaned prior to scanning with the laser beam, although this is not ruled out; e.g., the surface can be cleaned or acid-cleaned with a solvent. A removal of a predominantly organic layer, such as, e.g., an adhesive layer or paint layer, and a nanostructuring/chemical surface modification can even be achieved during a scanning process. Prior to scanning with a laser beam, it is preferred that the surface not be treated with an adhesion-promoting agent, such as, e.g., a silane adhesion-promoting agent, a titanate, such as titanium tetraisopropylate or titanium acetylacetonate, a zirconate, such as zirconium tetrabutylate, a zirconium aluminate, a thiazole, a triazole, such as 1H-benzotriazole, a phosphonate or a sulfonate, to increase the adhesive strength on a material to be connected to the surface or to be applied to said surface. These types of adhesion-promoting agents are frequently not applied even after scanning.

The metal or metal alloy possibly coated with an oxide layer, in which the method according to the invention can be carried out, is not subject to any restrictions. It can be can be selected for example from iron, aluminum, tantalum, copper, nickel, magnesium or titanium or an alloy of same, e.g., from Ti-6Al-4V, pure titanium, Mg-4Al1-Zn, Ta-10W, Cu—OF, CuZn37, Al 2024 (Al-4.4Cu-1.5Mg-0.6Mn), V2A steel (X5CrNi18-10) and Inconel 718® (high-temperature nickel alloy with Ni-19Cr-18Fe-5Nb-3Mo-0.05C (material no. 2.4668)).

The boiling point under standard pressure, the specific heat capacity cₚ under normal conditions, the specific thermal conductivity κ under normal conditions and the absorption of the laser radiation of the irradiated material α under normal conditions, which are to be used in the aforementioned expression for ε, are therefore simply material properties of the treated metal or the treated metal alloy. In the case of metals or metal alloys covered with an oxide layer, the data of the underlying metal or metal alloy are used.

It should still be mentioned that naturally only those surface regions that can be reached by a laser light can be treated. Regions that are completely “in the shadows” (e.g., in the case of undercut geometries) cannot be structured in the manner described herein.

The mechanism of surface structuring while simultaneously chemically modifying the surface of the metal or the metal alloy or the oxide layer on the metal or the metal alloy is currently not understood completely. However, it is assumed that the chemical modification is effected by the development of very reactive atoms or atom groups from the gas in the laser beam and the penetration thereof into the surface of the laser-exposed and thereby partially molten material, where they either remain or link to another atom in the surface and leave same again.

The gas or gas mixture that reacts with the surface of the metal or the metal alloy or the metal oxide layer or the metal alloy oxide layer on the metal or the metal alloy can, in principle, be any gas or gas mixture with the exception of noble gases, wherein the extent of the reaction is naturally a function of the respective gas and the respective surface.

Included in the reacting gases are, for example, inorganic gases or gas mixtures such as, e.g., hydrogen, air, oxygen, nitrogen, halogens, carbon monoxide, carbon dioxide, ammonia, nitrogen monoxide, nitrogen dioxide, nitrous oxide, sulfur dioxide, hydrogen sulfide, boranes and/or silanes (e.g., monosilane and/or disilane).

Organic gases or gases with organic groups can also be used. These include, e.g., lower, possibly halogenated, alkanes, alkenes and alkines, such as methane, ethane, ethene (ethylene), propene (propylene), ethine (acetylene), methyl fluoride, methyl chloride and methyl bromide, as well as methylamine and methylsilane. A mixture of an inorganic and organic gas or a gas containing organic groups can also be used.

If a gas mixture is present, it is sufficient that a gas component of same or a mixture of several gas components is a reacting gas; the rest can be an inert gas, as a rule a noble gas. The concentration of the reacting gas or gas mixture can vary from a few ppb, e.g. 5 ppb, to more than 99% by volume.

Naturally, the selection of the gas or gas mixture depends upon the intended modification of the metal surface, metal alloy surface, metal oxide surface or metal alloy oxide surface. If a metal oxide surface is supposed to be activated, i.e., supposed to be converted to a pure nanostructured metal, one would consider hydrogen first and foremost as the reacting gas (possibly in a mixture with an inert gas) in order to deoxygenate the surface. On the other hand, for a hardening of the surface, a gas containing nitrogen, oxygen or carbon, from which nitrogen, oxygen and carbon atoms are incorporated into the surface, will frequently be considered. Which reacting gas to select in order to achieve a desired effect with it in the case of a given metallic material or possibly the oxide-coated surface thereof is known to a person skilled in the art.

The pressure of the gas or gas mixture is generally in a range of approx. 0.001 mbar to approx. 15 bar. Work can be performed at gas temperatures that are outside of the laser beam generally in a range of approx. −50° C. to approx. 350° C. Naturally, substantially higher temperatures can develop in the laser beam.

A chemical modification that has taken place to a given surface can be investigated using suitable analysis methods, such as XPS (X-ray photoelectron spectroscopy), EDX (energy dispersive X-ray analysis), FTIR (Fourier transform infrared) spectroscopy, TOF-SIMS (time of flight secondary ion mass spectrometry), EELS (electron energy loss spectroscopy), HAADF (high angle annular dark field) or NIR (near infrared spectroscopy).

The values of ε, which must be yielded from the parameters of the foregoing equation, so that surface structuring striven for according to the invention is achieved, are preferably at approx. 0.07≦ε≦approx. 2000, more preferably at approx. 0.07≦ε≦approx. 1500.

Preferred parameters of the method are indicated in the following. It must be emphasized that it is possible to vary all parameters independently of one another.

The pulse length of the laser pulses t is preferably approx. 0.1 ns to approx. 300 ns, more preferably approx. 5 ns to approx. 200 ns.

The pulse peak power of the exiting laser radiation Pₚ is preferably approx. 1 kW to approx. 1800 kW, more preferably approx. 3 kW to approx. 650 kW.

The average power of the exiting laser radiation Pₘ is preferably approx. 5 W to approx. 28000 W, more preferably approx. 20 W to approx. 9500 W.

The repetition rate of the laser pulses f is preferably approx. 10 kHz to approx. 3000 kHz, more preferably approx. 10 kHz to approx. 950 kHz.

The scanning speed on the workpiece surface v is preferably approx. 30 mm/s to approx. 19000 mm/s, more preferably approx. 200 mm/s to approx. 9000 mm/s.

The diameter of the laser beam on workpiece d is preferably approx. 20 μm to approx. 4500 μm, more preferably approx. 50 μm to approx. 3500 μm.

As mentioned above, the laser wavelength λ can be approx. 100 nm to approx. 11000 nm. The following can be used as the laser: e.g., solid-state laser, such as, e.g., Nd:YAG (λ=1064 nm or 533 nm or 266 nm), Nd:YVO₄ (λ=1064 nm), diode laser with e.g., λ=808 nm, gas laser, such as, e.g., excimer laser, with, e.g., KrF (λ=248 nm) or H₂ (λ=123 nm or 116 nm) or a CO₂ laser (10600 nm).

The chemically modified surfaces produced according to the invention can ensure, e.g., an excellent adhesion of adhesives, paints and other coatings. Furthermore, chemically modified nanostructured surfaces can be produced, which show a high level of resistance to corrosion or abrasion, or are very hydrophobic, which impedes or prevents the adherence of aqueous media, ice and biological organisms.

In embodiments of the method of the invention, after structuring of the surface, the surface is bonded with or without adhesive to a surface of a second workpiece into a workpiece composite or is provided with a coating or is chemically modified.

If, according to the invention, nanostructures comprising a chemical modification are produced on at least one metal or metal oxide, it is possible for two metals, one metal and one metal oxide or two metal oxides or one metal or metal oxide to be connected together to another material by mere joining under increased pressure, such as by a rolling process at room temperature (e.g., cold rolling of chemically modified gold) or at increased temperatures (e.g., accumulative roll bonding) or by a micro-forging process (e.g., cold gas spraying), with satisfactory adhesion to form a workpiece composite. If necessary, however, every adhesive for this purpose known to a person skilled in the art can also be used to encourage the bonding.

The coating can be any desired coating for metal and metal oxides and it can be applied in any appropriate manner.

Cited as examples of such coatings are solders, coatings applied by thermal and non-thermal spraying, paints, other coatings with glass-like materials, ceramics and inorganic-organic or organic materials, which are possibly generated directly on the surface according to the invention, along with biochemical and biological materials, e.g. cells and/or body tissue.

Polyurethane-based, acrylic-based, vinyl-based and epoxy-based coatings as well as zinc-rich inorganic and inorganic-organic coatings are cited as special examples of paints and similar coatings. Another example are silane coatings, e.g., silanes polymerizing to siloxanes (available, e.g., under the trade name of Oxsilan®), which can be applied in particular to surfaces structured according to the invention that contain oxygen atoms.

If a coating of an adhesion-promoting agent is being used, silane adhesion-promoting agents, among others, can be applied to the surface. An example of such an adhesion-promoting agent that can be applied to oxygen-free structured metal surfaces is an aqueous solution (sol) of zirconium salts activated by organosilicon compounds, which supplies an adhesion-promoting gel after vaporization of the water (available, e.g., under the trade names of SOCOGEL® or Alodine® SG 8800).

As mentioned in the foregoing, the structured surfaces can also be chemically modified in any manner known to a person skilled in the art, e.g. by chemical transformation to produce conversion layers, which have an anticorrosive effect, among other things. In this case, classical chromating with chromium (VI), chromating with reagents based on chromium (III) (e.g., SurTec® 650), chromium-free zinc phosphating or the application of chromium-free zirconium, titanium or vanadium conversion layers can be cited.

The following examples explain the invention without restricting it.

### EXAMPLES

### Example 1

A rolled sheet of the Ti-6Al-4V alloy was scanned at room temperature without pretreatment once with a diode-pumped Nd:YVO₄ (neodymium-pumped yttrium orthovanadate) laser (wavelength λ: 1064 nm) in an argon atmosphere (pressure approx. 1.5 bar) and once in a nitrogen atmosphere (pressure approx. 1.5 bar).

The remaining process parameters were:

Pₚ (Pulse peak power of the exiting laser radiation): 38 kW
Pₘ (Average power of the exiting laser radiation): 6 W
t (Pulse length of the laser pulses): 17 ns
f (Repetition rate of the laser pulses) 10 kHz
v (Scanning speed on the workpiece surface): 800 mm/s
d (Diameter of the laser beam on the workpiece): 80 μm
α (Absorption of the laser radiation of the irradiated material): 15%
Tᵥ (Boiling point of the material under standard pressure): 3560 K
cₚ (Specific heat capacity): 580 J/kgK
κ (Specific thermal conductivity) 22 W/mK
This yields ε=1.2; i.e., ε lies in the range according to the invention.

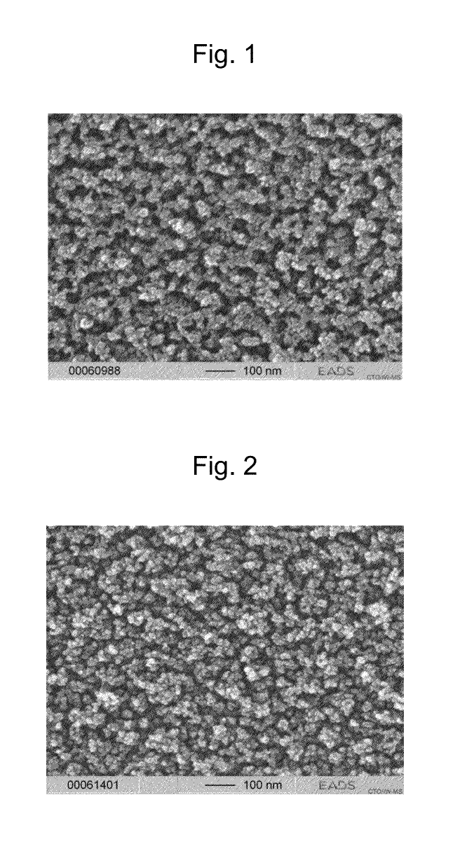

The surface structures of the two samples are shown in the SEM images of FIG. 1 (argon sample) and FIG. 2 (nitrogen sample).

The elemental composition of the surface of the two samples was analyzed after the laser treatment using X-ray photoelectron spectroscopy (XPS). The spectra were recorded with a Physical Electronics Quantum 2000 System (at 15 kV and 24 W), at a pressure in the sample chamber of 6×10⁻⁹ mbar, a penetration depth of 50 Å on an area having a diameter of 100 mm (sensitivity factors: carbon: 0.278; oxygen: 0.780; nitrogen: 0.477).

The results are summarized in the following Table 1.

TABLE 1

| | At % | | | | | | | | | | |
|---|---|---|---|---|---|---|---|---|---|---|---|
| Sample | C | N | O | F | Na | Al | Si | Cl | Ca | Ti | V |
| Ti—6Al—4V laser treated in | 19.8 | 0.7 | 58.1 | — | — | 3.0 | — | — | — | 17.4 | 1.0 |
| an Ar atmosphere | | | | | | | | | | | |
| Ti—6Al—4V laser treated in | 21.7 | 4.0 | 52.5 | — | — | 26 | — | — | — | 18.2 | 1.1 |
| an N₂ atmosphere | | | | | | | | | | | |

As the table shows, a portion of the oxygen is displaced by nitrogen on the oxidized surface of the alloy when the laser treatment takes place in a nitrogen atmosphere.

### Example 2

A rolled sheet of the Al2024 alloy (Al-4.4Cu-1.5Mg-0.6Mn) was scanned at ambient temperature in an oxygen atmosphere (pressure 2 bar) without any pretreatment once with a diode-pumped Nd:YAG (neodymium-pumped yttrium-aluminum garnet) laser (wavelength λ: 533 nm).

The remaining process parameters were:

Pₚ: 68 kW; Pₘ: 77 W; t: 57 ns; f: 20 kHz; v: 100 mm/s; d: 80 μm; α: 45%;
Tᵥ: 2543 K; cₚ: 897 J/kgK; κ: 80 W/mK
This yields ε=1873; i.e., ε lies in the range according to the invention.

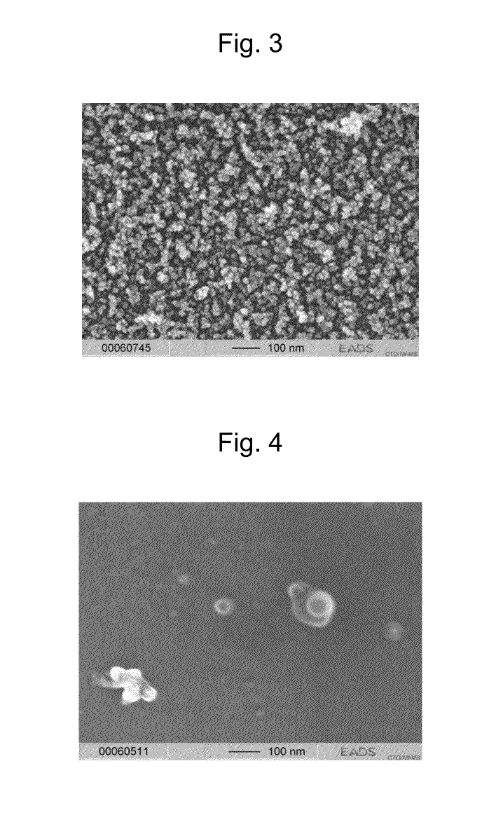

The surface structure produced in the sample treated in an oxygen atmosphere is shown in the SEM image in FIG. 3. For purposes of comparison, FIG. 4 shows an untreated Al2024 surface with the same magnification.

The elemental composition of the surface of the two samples was analyzed after laser treatment using X-ray photoelectron spectroscopy (XPS). The spectra were recorded with a Physical Electronics Quantum 2000 System (at 15 kV and 24 W), at a pressure in the sample chamber of 6×10⁻⁹ mbar, a penetration depth of 50 Å on an area having a diameter of 100 mm (sensitivity factors: carbon: 0.278; oxygen: 0.780; nitrogen: 0.477).

The results are summarized in the following Table 2.

TABLE 2

| | At % | | | | | | | | | | |
|---|---|---|---|---|---|---|---|---|---|---|---|
| Sample | C | N | O | F | Na | Al | Si | Cl | Ca | Ti | V |
| Al 2024 untreated | 46.0 | 1.3 | 34.4 | 0.2 | 0.5 | 17.0 | 0.3 | 0.1 | 0.2 | — | — |
| Al 2024 laser treated in an | 12.8 | — | 62.3 | — | — | 24.7 | — | 0.2 | — | — | — |
| O₂ atmosphere | | | | | | | | | | | |

As the table shows, during the laser treatment the oxygen reacted with the carbon in the sample forming a gas (CO or CO₂), which is vaporized from the surface. At the same time, considerable quantities of oxygen were incorporated in the surface.

### Example 3

### Wear Resistance Test

The wear resistance for example can be increased by a chemical modification. This was demonstrated on the sample of the Ti-6Al-4V alloy that was laser treated in a nitrogen atmosphere.

For this purpose, in a so-called ball-on-plate test, a spherical geometry is pressed on the flat sample. The plate to which the sample is fastened is moved back and forth in the process. The abrasive wear of the tribological system was tested in the process. The test device that was used was a TE 800 Multi Station Friction from Plint & Partners Ltd, wherein a ball made of 100Cr6 having a diameter of 8 mm was used.

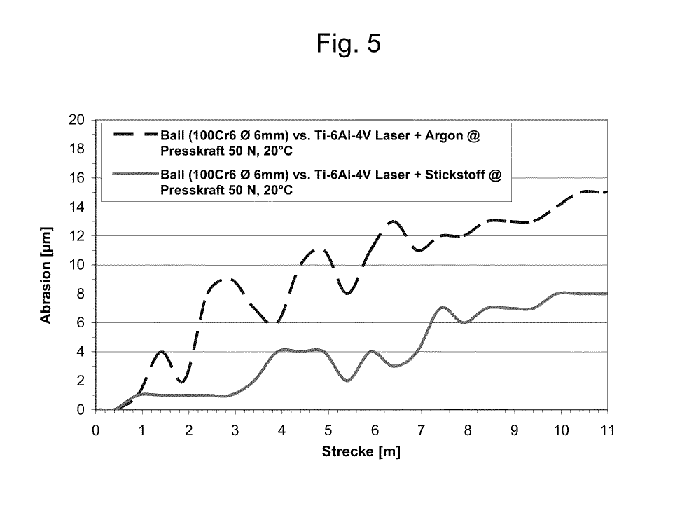

As FIG. 5 shows, the abrasive wear in the case of a surface that was nanostructured in a N2 atmosphere is considerably lower than in the case of a surface that was nanostructured in an Ar atmosphere.

All documents cited herein, such as patents, patent applications, journal articles and standards, are hereby incorporated by reference in this patent application. The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-16. (canceled)

17. A method for structuring a surface of a workpiece, which surface comprises a metal or a metal alloy or a metal oxide layer or a metal alloy oxide layer present on a metal or metal alloy surface, the method comprising:
producing surface structures having dimensions in the sub-micrometer range by scanning, once or several times by a pulsed laser beam, an entire surface of the metal or the metal alloy or the metal oxide layer or the metal alloy oxide layer on the metal or the metal alloy, which surface or layer is accessible to laser radiation, wherein the scanning is performed in such a way that adjacent flecks of light of the laser beam adjoin each other without an interspace in between or overlap, wherein the following conditions are satisfied
approximately 0.07≦ε≦approximately 2300
with
$$ɛ = \frac{{P}_{P}^{2} \cdot \sqrt{{P}_{m}} \cdot f \cdot α \cdot \sqrt{t} \cdot \sqrt{κ}}{{d}^{2} \cdot \sqrt{v} \cdot \sqrt{{T}_{V}} \cdot \sqrt{{c}_{P}} \cdot \sqrt{λ}} \cdot {10}^{3}$$
wherein:
Pₚ: Pulse peak power of the exiting laser radiation [kW]
Pₘ: Average power of the exiting laser radiation [W]
t: Pulse length of the laser pulses [ns], wherein t is approximately 0.1 ns to approximately 2000 ns,
f: Repetition rate of the laser pulses [kHz]
v: Scanning speed on the workpiece surface [mm/s]
d: Diameter of the laser beam on the workpiece [μm]
α: Absorption of the laser radiation of the irradiated material [%] under normal conditions
λ: Wavelength of the laser radiation [nm], wherein λ=approximately 100 nm to approximately 11000 nm
Tᵥ: Boiling point of the material [K] under standard pressure
cₚ: Specific heat capacity [J/kg·K] under normal conditions
κ: Specific thermal conductivity [W/m·K] under normal conditions,
wherein an atmosphere, in which the method is carried out, is a gas or gas mixture that reacts with the surface of the metal or the metal alloy or the metal oxide layer or the metal alloy oxide layer on the metal or the metal alloy.

18. The method of claim 17, wherein a pressure of the atmosphere is in a range of approximately 0.001 mbar to approximately 15 bar and a temperature of the atmosphere outside the laser beam is in a range of approximately −50° C. to approximately 350° C.

19. The method of claim 17, wherein approximately 0.07≦ε≦approximately 2000, more preferably approximately 0.07≦ε≦approximately 1500.

20. The method of claim 17, wherein approximately 0.07≦ε≦approximately 1500.

21. The method of claim 17, wherein the reacting gas or gas mixture is selected from an inorganic gas or gas mixture, an organic gas or gas mixture, or a gas or gas mixture containing organic groups or a mixture of same, wherein the gas or gas mixture is present in a mixture with a noble gas.

22. The method of claim 17, wherein the pulse length of the laser pulses t is approximately 0.1 ns to approximately 300 ns.

23. The method of claim 17, wherein the pulse length of the laser pulses t is approximately 5 ns to approximately 200 ns.

24. The method of claim 17, wherein the metal surface is not pretreated or cleaned prior to the irradiation with the laser beam.

25. The method of claim 17, wherein the metal or the metal alloy is selected from iron, aluminum, magnesium, tantalum, copper, nickel or titanium or an alloy of same.

26. The method of claim 17, wherein the pulse peak power of the exiting laser radiation Pₚ is approximately 1 kW to approximately 1800 kW.

27. The method of claim 17, wherein the average power of the exiting laser radiation Pₘ is approximately 5 W to approximately 28000 W.

28. The method of claim 17, wherein the repetition rate of the laser pulses f is approximately 10 kHz to approximately 3000 kHz.

29. The method of claim 17, wherein the scanning speed on the workpiece surface v is approximately 30 mm/s to approximately 19000 mm/s.

30. The method of claim 17, wherein the diameter of the laser beam on workpiece d is approximately 20 μm to approximately 4500 μm.

31. The method of claim 17, wherein, after structuring the surface, the surface is bonded with or without adhesive to a surface of a second workpiece into a workpiece composite or is provided with a coating or is chemically modified.

32. A workpiece comprising:
a surface of a metal or a metal alloy or a metal oxide layer or metal alloy oxide layer on the surface of the metal or the metal alloy, wherein the surface has a chemically modified structure that can be produced by
scanning, once or several times by a pulsed laser beam, an entire surface of the metal or the metal alloy or the metal oxide layer or the metal alloy oxide layer on the metal or the metal alloy, which surface or layer is accessible to laser radiation, wherein the scanning is performed in such a way that adjacent flecks of light of the laser beam adjoin each other without an interspace in between or overlap, wherein the following conditions are satisfied
approximately 0.07≦ε≦approximately 2300
with
$$ɛ = \frac{{P}_{P}^{2} \cdot \sqrt{{P}_{m}} \cdot f \cdot α \cdot \sqrt{t} \cdot \sqrt{κ}}{{d}^{2} \cdot \sqrt{v} \cdot \sqrt{{T}_{V}} \cdot \sqrt{{c}_{P}} \cdot \sqrt{λ}} \cdot {10}^{3}$$
wherein:
Pₚ: Pulse peak power of the exiting laser radiation [kW]
Pₘ: Average power of the exiting laser radiation [W]
t: Pulse length of the laser pulses [ns], wherein t is approximately 0.1 ns to approximately 2000 ns,
f: Repetition rate of the laser pulses [kHz]
v: Scanning speed on the workpiece surface [mm/s]
d: Diameter of the laser beam on the workpiece [μm]
α: Absorption of the laser radiation of the irradiated material [%] under normal conditions
λ: Wavelength of the laser radiation [nm], wherein λ=approximately 100 nm to approximately 11000 nm
Tᵥ: Boiling point of the material [K] under standard pressure
cₚ: Specific heat capacity [J/kg·K] under normal conditions
κ: Specific thermal conductivity [W/m·K] under normal conditions,
wherein an atmosphere, in which the method is carried out, is a gas or gas mixture that reacts with the surface of the metal or the metal alloy or the metal oxide layer or the metal alloy oxide layer on the metal or the metal alloy.

33. The workpiece of claim 32, wherein the surface comprises open-pored, ragged and/or fractal-like hill and valley structures, undercut and/or nodule-like structures, the dimensions of which are less than 1 μm with the exception of the valley lengths of the hill and valley structures.

34. A workpiece or workpiece composite, comprising:
a surface of a metal or a metal alloy or a metal oxide layer or metal alloy oxide layer on the surface of the metal or the metal alloy, wherein the surface has a chemically modified structure that can be produced by
scanning, once or several times by a pulsed laser beam, an entire surface of the metal or the metal alloy or the metal oxide layer or the metal alloy oxide layer on the metal or the metal alloy, which surface or layer is accessible to laser radiation, wherein the scanning is performed in such a way that adjacent flecks of light of the laser beam adjoin each other without an interspace in between or overlap, wherein the following conditions are satisfied
approximately 0.07≦ε≦approximately 2300
with
$$ɛ = \frac{{P}_{P}^{2} \cdot \sqrt{{P}_{m}} \cdot f \cdot α \cdot \sqrt{t} \cdot \sqrt{κ}}{{d}^{2} \cdot \sqrt{v} \cdot \sqrt{{T}_{V}} \cdot \sqrt{{c}_{P}} \cdot \sqrt{λ}} \cdot {10}^{3}$$
wherein:
Pₚ: Pulse peak power of the exiting laser radiation [kW]
Pₘ: Average power of the exiting laser radiation [W]
t: Pulse length of the laser pulses [ns], wherein t is approximately 0.1 ns to approximately 2000 ns,
f: Repetition rate of the laser pulses [kHz]
v: Scanning speed on the workpiece surface [mm/s]
d: Diameter of the laser beam on the workpiece [μm]
α: Absorption of the laser radiation of the irradiated material [%] under normal conditions
λ: Wavelength of the laser radiation [nm], wherein λ=approximately 100 nm to approximately 11000 nm
Tᵥ: Boiling point of the material [K] under standard pressure
cₚ: Specific heat capacity [J/kg·K] under normal conditions
κ: Specific thermal conductivity [W/m·K] under normal conditions,
wherein an atmosphere, in which the method is carried out, is a gas or gas mixture that reacts with the surface of the metal or the metal alloy or the metal oxide layer or the metal alloy oxide layer on the metal or the metal alloy,
wherein, after structuring the surface, the surface is bonded with or without adhesive to a surface of a second workpiece into a workpiece composite or is provided with a coating or is chemically modified.
